(19) United States
(12) Patent Application Publication
(10) Pub. No.: US 2004/0108011 A1
(43) Pub. Date: Jun. 10, 2004

(54) Hose for a fuel feed device

(76) Inventors: Karl Eck, Frankfurt (DE); Sabine Reichelt, Neu-Isenburg (DE)

Correspondence Address: Richard A. Speer, MAYER, BROWN, ROWE & MAW, P.O. Box 2828, Chicago, IL, 60690-2828, US

(21) Appl. No.: 10/681,460

(22) Filed: Oct. 6, 2003

(30) Foreign Application Priority Data
Oct. 21, 2002 (DE) 102 48 978.5

(51) Int. Cl. F16L 55/00

(52) U.S. Cl. 138/104; 138/137; 138/124; 138/121

(57) ABSTRACT

A hose for a fuel feed device of a motor vehicle having a wall (3, 7, 11, 16) manufactured from electrically nonconductive plastic and having an electrical conductor (4, 6, 12-14) that can be connected to a ground (5) of the motor vehicle to discharge electrical charges generated when fuel flows through the hose.

### BACKGROUND OF THE INVENTION

The invention relates to a hose for a fuel feed device of a motor vehicle, with an elastic and electrically conductive wall.

Such hoses are often used in forward-flow lines of fuel feed devices. Particularly in the case of what are known as common-rail applications, high volume flows are fed through the hose. In order to avoid the hose being charged electrically, hoses with a wall consisting of electrically conductive rubber have become known from practice. However, such hoses are highly cost-intensive to manufacture.

The problem on which the invention is based is to design a hose of the type initially mentioned in such a way that it can be produced particularly cost-effectively.

This problem is solved, according to the invention, in that the wall consists of an electrically nonconductive plastic and has at least one electrical conductor connected to one end of the hose.

By virtue of this design, the hose according to the invention can be manufactured from a plastic which is particularly cost-effective and/or is particularly simple to process. The electrical conductor discharges via one end of the hose electrical charges which are generated as a result of a high volume flow. The hose according to the invention can thereby be manufactured particularly cost-effectively.

### BRIEF DESCRIPTION OF THE INVENTION

The hose according to the invention is designed particularly simply in structural terms when the electrical conductor is arranged parallel to the axis of the hose or peripherally on the surface of the wall. The electrical conductor may be, for example, a wire.

According to another advantageous development of the invention, the connection of the electrical conductor to the wall requires a particularly low outlay when the electrical conductor is designed as a track connected to the wall in a materially integral or positive manner. Such a track can, for example, be printed onto the wall.

The wall of the hose according to the invention can be manufactured from virtually any desired materials when the wall has a sheathing and when the sheathing is manufactured from conductive material or contains individual conductive fibers.

The sheathing increases the stability of the hose according to the invention when the sheathing is designed as a fabric hose.

A contribution to further reducing the charge of the hose according to the invention is made when the electrical conductor connects the outside and/or the inside of the wall to one another in an electrically conductive manner.

A contribution to further reducing the manufacturing costs of the hose according to the invention is made when the electrical conductor is manufactured from conductive plastic.

According to another advantageous development of the invention, the connection of the electrical conductor to nonconductive parts of the wall has a particularly high stability when the conductor is designed as part of the wall. For production, the conductor can simply be injected into the wall by the injection-molding method during the manufacture of the hose according to the invention. Alternatively to this, the conductor may also be injection-molded onto the wall.

The wall of the hose according to the invention could have, for example, a planar surface. However, the hose according to the invention can be laid particularly simply when it is designed as a corrugated hose.

### BRIEF DESCRIPTION OF THE DRAWINGS

The invention permits numerous embodiments. To make its basic principle even clearer, several of these are illustrated in the drawing and are described below. In the drawing:

FIG. 1 shows a view of a hose according to the invention,

FIG. 2 shows a further embodiment of the hose according to the invention,

FIG. 3 shows a further embodiment of the hose according to the invention in cross section,

FIG. 4 shows a cross section through a further embodiment of the hose according to the invention.

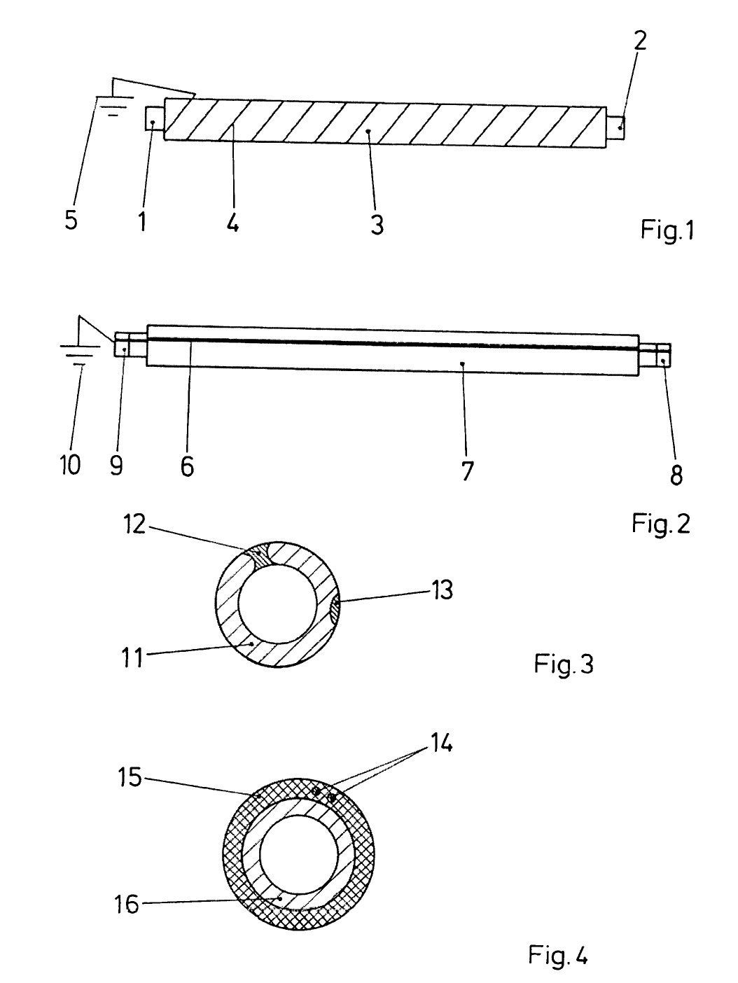

FIG. 1 shows a hose with connection pieces 1, 2 arranged at its ends. The hose has a wall 3 consisting of electrically nonconductive plastic and an electrical conductor 4 arranged peripherally thereon. The hose is intended for use in a forward-flow line of a fuel feed unit, not illustrated, of a motor vehicle and, via the electrical conductor 4, has a connection to a ground 5 of the motor vehicle. The electrical conductor 4 may be, for example, a wire wound on the wall 3 of the hose or a glued-on conductor track. The hose has a planar surface. In an alternative embodiment, not illustrated, the hose may also be designed as a corrugated hose with a wavy wall.

FIG. 2 shows a further embodiment of the hose, in which an electrical conductor 6 is arranged parallel to the axis of the hose on an electrically nonconductive wall 7. The electrical conductor 6 connects two connection pieces 8, 9 arranged on the ends of the hose. One of the connection pieces 9 has a connection to a ground 10 of the motor vehicle.

FIG. 3 shows a further embodiment of the hose, in which two electrical conductors 12, 13 are arranged in an electrically nonconductive wall 11. One of the electrical conductors 12 penetrates through the wall 11 and thus makes a connection to fuel carried in the hose. The other electrical conductor 13 is arranged on the outside of the wall 11. The two electrical conductors 12, 13 are manufactured in a materially integral way with the wall 11 of the hose and from electrically conductive plastic. The hose can be manufactured, for example, by the extrusion method, in that the plastic of the electrical conductors 12, 13 is introduced, together with the plastic of the wall 11, into the extrusion die. Alternatively to this, the electrical conductor 13 not penetrating through the wall 11 may also be injection-molded onto the wall 11 in a concluding operation.

FIG. 4 shows a further embodiment of the hose, in which an electrical conductor 14 is arranged in a sheathing 15 of the wall 16 manufactured from electrically nonconductive material. The sheathing 15 may be designed as a conductive fabric hose or as a fabric hose with individual conductive fibers.

1. A hose for a fuel feed device of a motor vehicle, with an elastic and electrically conductive wall, characterized in that the wall (3, 7, 11, 16) consists of an electrically nonconductive plastic and has at least one electrical conductor (4, 6, 12-14) connected to one end of the hose.

2. The hose as claimed in claim 1, characterized in that the electrical conductor (4, 6, 12-14) is arranged parallel to the axis of the hose or peripherally on the surface of the wall (3, 7, 11, 16).

3. The hose as claimed in claim 1 or 2, characterized in that the electrical conductor (4, 6, 12, 13) is designed as a track connected to the wall (3, 7, 11) in a materially integral or positive manner.

4. The hose as defined in claim 1, characterized in that the wall (16) has a conductive sheathing (15).

5. The hose as defined in claim 4, characterized in that the sheathing (15) is designed as a fabric hose.

6. The hose as defined in 1, characterized in that the electrical conductor (12) connects the outside and the inside of the wall (11) to one another in an electrically conductive manner.

7. The hose as defined in claim 1, characterized in that the electrical conductor (4, 6, 12-14) is manufactured from conductive plastic.

8. The hose as defined in claim 1, characterized in that the conductor (4, 6, 12, 13) is designed as part of the wall (3, 7, 11).

9. The hose as defined in claim 1, characterized in that the hose is designed as a corrugated hose.
